(19) United States
(12) Patent Application Publication
(10) Pub. No.: US 2016/0098651 A1
(43) Pub. Date: Apr. 7, 2016

(54) SELF-SERVICE MODEL DESIGNER FOR FEDERATED FINANCIAL PLANNING AND ANALYSIS

(71) Applicant: HOST ANALYTICS, INC., Redwood City, CA (US)

(72) Inventors: Steve Tak-Shu TAI, Menlo Park, CA (US); Ajay Ratan SINGH, Redwood City, CA (US); Adnan Rashin HUSSAIN, Redwood City, CA (US)

(21) Appl. No.: 14/869,241

(22) Filed: Sep. 29, 2015

Related U.S. Application Data
(60) Provisional application No. 62/058,330, filed on Oct. 1, 2014.

(51) Int. Cl. G06Q 10/06

(52) U.S. Cl. CPC G06Q 10/067

(57) ABSTRACT

A methods and apparatuses for creating a federated multidimensional business planning model may comprise: creating, via a computing device, a first multidimensional business planning model; creating, via a computing device, a second multidimensional business planning model; integrating, via a computing device, the first multidimensional business planning model with the second multidimensional business planning model, wherein the integrating comprises mapping, via a computing device, dimensions of the first multidimensional business planning model to the second multidimensional business planning model, utilizing user input through a model map spreadsheet worksheet defining, via a computing device, at least one source dimension in the first multidimensional business planning model corresponding with at least one target dimension in the second multidimensional business planning model.

### CROSS-REFERENCE

This application claims the benefit of U.S. Provisional Application No. 62/058,330, filed Oct. 1, 2014, entitled SELF-SERVICE MODEL DESIGNER FOR FEDERATED FINANCIAL PLANNING AND ANALYSIS which application is incorporated herein by reference.

### BACKGROUND

Corporations that have many diverse business units would prefer to use a federated approach to financial planning and analysis (FP&A). As a result, these corporations faced challenges pulling together an integrated financial plan in a timely fashion that can synchronize short-term bottom-up business unit financial plans with long-term top-down corporate financial plans.

Modeling approaches can differ between corporate and business unit teams, which can impede focused discussions about business drivers and assumptions. These differences have caused excessive effort to collect and consolidate data, long cycle times, as well as increased risk of planning inaccuracy and decision-making based on such faulty plans.

In computing, online analytical processing (“OLAP”), is an approach to answering multi-dimensional analytical (“MDA”) queries swiftly. OLAP is part of the broader category of business intelligence, which also encompasses relational databases, report writing and data mining. Typical applications of OLAP include business reporting for sales, marketing, management reporting, business process management (“BPM”), budgeting and forecasting, financial reporting and similar areas. The term OLAP was created as a slight modification of the traditional database term Online Transaction Processing (“OLTP”). OLAP tools enable users to analyze multidimensional data interactively from multiple perspectives. OLAP consists of three basic analytical operations: consolidation (roll-up), drill-down, and slicing and dicing. Consolidation involves the aggregation of data that can be accumulated and computed in one or more dimensions. For example, all sales offices may be rolled up to the sales department or sales division to anticipate sales trends. By contrast, drill-down is a technique that allows users to navigate through the details. For instance, users can view the sales by individual products that make up a region's sales. Slicing and dicing is a feature whereby users can take out (slicing) a specific set of data from an OLAP cube and view (dicing) the slices from different viewpoints. Databases configured for OLAP use a multidimensional data model, allowing for complex analytical and ad hoc queries with a rapid execution time. They borrow aspects of navigational databases, hierarchical databases and relational databases. See, http://en.wikipedia.org/wiki/Online_analytical_processing.

What is needed are tools for complying with the complex reporting required by businesses today; particularly where the reporting of multiple business units needs to be accounted for by a parent company.

### SUMMARY

The disclosed subject matter provides a much needed technical solution to the complex reporting required by businesses today. The providing an integrated planning tool, e.g., utilizing OLAP or the like, that automates and unifies the business unit and corporate financial planning processes around common driver models and thus share a single version of the collective reality by controlling the computing system in a novel way to achieve the desired technical result of improved reporting and data analytics.

It will be understood by those skilled in the art that methods and apparatuses for creating a federated multidimensional business planning model are disclosed, which may comprise: creating, via a computing device, a first multidimensional business planning model; creating, via a computing device, a second multidimensional business planning model; integrating, via a computing device, the first multidimensional business planning model with the second multidimensional business planning model, wherein the integrating comprises mapping, via a computing device, dimensions of the first multidimensional business planning model to the second multidimensional business planning model, utilizing user input through a model map spreadsheet worksheet defining, via a computing device, at least one source dimension in the first multidimensional business planning model corresponding with at least one target dimension in the second multidimensional business planning model.

The methods and apparatuses may further comprise, wherein at least one of the at least one source dimension in the first multidimensional business planning model has a different dimension name than the corresponding at least one target dimension in the second multidimensional business planning model. In addition, the dimension name of the at least one source dimension in the first multidimensional business planning model and the dimension name of the corresponding least one target dimension in the second multidimensional business planning model may be, respectively, contained in a value table and a lookup table of a lookup spreadsheet worksheet. Further, a dimension may comprise either a dynamic dimension, changeable after the model is created, or a static dimension, not changeable after the model is created. Still further, each of the first multidimensional business planning model and the second multidimensional business planning model may be identified by a model type and a model creator.

The methods and apparatuses according to aspects of the disclosed embodiments may additionally have each dimension have a unique rollup defined by a dimension hierarchy of data members within the dimension and a data member parent for each data member in the dimension. The methods and apparatuses may still further comprise utilizing user input through a model setup spreadsheet worksheet, defining, via a computing device, a rollup operator relationship between each dimension data member and the corresponding dimension parent data member. In another example of the disclosed subject matter, the methods and apparatuses may utilize user input through a model setup spreadsheet worksheet, to define, via a computing device, each user by a user role and a user access for each of the first multidimensional business planning model, the second multidimensional business planning model and the integrated first multidimensional business planning model and second multidimensional business planning model. Also, methods and apparatuses may comprise, utilizing user input through a data load spreadsheet worksheet to load, via a computing device, data into a model for an identified member of a first dimension and a corresponding member of a second dimension, wherein the corresponding member of the second dimension is variable and the variation acts as a filter for the loaded data.

A computer readable medium is also disclosed for storing instructions that, when executed by a computing device, cause the computing device to perform a method, which method may comprise: creating a first multidimensional business planning model; creating a second multidimensional business planning model; integrating the first multidimensional business planning model with the second multidimensional business planning model, wherein the integrating comprises mapping dimensions of the first multidimensional business planning model to the second multidimensional business planning model, utilizing user input through a model map spreadsheet worksheet defining at least one source dimension in the first multidimensional business planning model corresponding with at least one target dimension in the second multidimensional business planning model.

Aspects of the disclosure include methods of creating a federated multidimensional business planning model. Suitable methods comprise: creating, via a computing device, a first multidimensional business planning model; creating, via a computing device, a second multidimensional business planning model; integrating, via a computing device, the first multidimensional business planning model with the second multidimensional business planning model, wherein the step of integrating comprises mapping, via a computing device, dimensions of the first multidimensional business planning model to the second multidimensional business planning model, utilizing user input through a model map spreadsheet worksheet defining, via a computing device, at least one source dimension in the first multidimensional business planning model corresponding with at least one target dimension in the second multidimensional business planning model. Additionally, at least one of the at least one source dimension in the first multidimensional business planning model has a different dimension name than the corresponding at least one target dimension in the second multidimensional business planning model. In at least some configurations, the dimension name of the at least one source dimension in the first multidimensional business planning model and the dimension name of the corresponding at least one target dimension in the second multidimensional business planning model are respectively contained in a value table and a lookup table of a lookup spreadsheet worksheet. A dimension can also comprises either a dynamic dimension, changeable after the federated multidimensional business planning model is created, or a static dimension, not changeable after the federated multidimensional business planning model is created. Each of the first multidimensional business planning model and the second multidimensional business planning model is identified by a model type and a model creator. In at least some instances, each dimension has a unique rollup defined by a dimension hierarchy of data members within the dimension and a data member parent for each data member in the dimension. For example methods can include utilizing user input through a model setup spreadsheet worksheet, defining, via a computing device, a rollup operator relationship between each dimension data member and the corresponding dimension parent data member. Additionally, methods can include utilizing user input through a model setup spreadsheet worksheet, defining, via a computing device, each user by a user role and a user access for each of the first multidimensional business planning model, the second multidimensional business planning model and the integrated first multidimensional business planning model and second multidimensional business planning model, and/or utilizing user input through a data load spreadsheet worksheet, loading, via a computing device, data into a model for an identified member of a first dimension and a corresponding member of a second dimension, wherein the corresponding member of the second dimension is variable and the variation acts as a filter for the loaded data.

Another aspect of the disclosure is directed to apparatuses for creating a federated multidimensional business planning model. Suitable apparatuses comprise: a computing device configured to: create a first multidimensional business planning model; create a second multidimensional business planning model; integrate the first multidimensional business planning model with the second multidimensional business planning model, wherein the integrating comprises mapping dimensions of the first multidimensional business planning model to the second multidimensional business planning model, utilizing user input through a model map spreadsheet worksheet defining at least one source dimension in the first multidimensional business planning model corresponding with at least one target dimension in the second multidimensional business planning model. In some instances, the apparatuses are configurable such that at least one of the at least one source dimension in the first multidimensional business planning model has a different dimension name than the corresponding at least one target dimension in the second multidimensional business planning model. Additionally, the dimension name of the at least one source dimension in the first multidimensional business planning model and the dimension name of the corresponding at least one target dimension in the second multidimensional business planning model can respectively contained in a value table and a lookup table of a lookup spreadsheet worksheet. A dimension can further be configurable to comprise either a dynamic dimension, changeable after the federated multidimensional business planning model is created, or a static dimension, not changeable after the federated multidimensional business planning model is created. Additionally, each of the first multidimensional business planning model and the second multidimensional business planning model is identified by a model type and a model creator. In at least some configurations, each dimension has a unique rollup defined by a dimension hierarchy of data members within the dimension and a data member parent for each data member in the dimension. The apparatuses can further comprise: the computing device further configured to: utilize user input through a model setup spreadsheet worksheet, defining a rollup operator relationship between each dimension data member and the corresponding dimension parent data member. Apparatuses can also be configurable such that the computing device further configured to utilize user input through a model setup spreadsheet worksheet to define each user by a user role and a user access for each of the first multidimensional business planning model, the second multidimensional business planning model and the integrated first multidimensional business planning model and second multidimensional business planning model. Some apparatuses are further configurable to comprise: the computing device further configured to: utilize user input through a data load spreadsheet worksheet to load data into a model for an identified member of a first dimension and a corresponding member of a second dimension, wherein the corresponding member of the second dimension is variable and the variation acts as a filter for the loaded data.

Still another aspect of the disclosure is directed to computer readable medium for storing instructions that, when executed by a computing device, cause the computing device to perform a method, the method comprising: creating a first multidimensional business planning model; creating a second multidimensional business planning model; integrating the first multidimensional business planning model with the second multidimensional business planning model, wherein the integrating comprises mapping dimensions of the first multidimensional business planning model to the second multidimensional business planning model, utilizing user input through a model map spreadsheet worksheet defining at least one source dimension in the first multidimensional business planning model corresponding with at least one target dimension in the second multidimensional business planning model. In some configurations, at least one of the at least one source dimension in the first multidimensional business planning model has a different dimension name than the corresponding at least one target dimension in the second multidimensional business planning model. Some configurations are also configurable to include a computing device means for creating a first multidimensional business planning model, creating a second multidimensional business planning model and integrating the first multidimensional business planning model with the second multidimensional business planning model, wherein the computing device means comprises integrating means for mapping dimensions of the first multidimensional business planning model to the second multidimensional business planning model, utilizing user input through a model map spreadsheet worksheet defining at least one source dimension in the first multidimensional business planning model corresponding with at least one target dimension in the second multidimensional business planning model. In at least some configurations, at least one of the at least one source dimension in the first multidimensional business planning model has a different dimension name than the corresponding at least one target dimension in the second multidimensional business planning model. Additionally, the dimension name of the at least one source dimension in the first multidimensional business planning model and the dimension name of the corresponding at least one target dimension in the second multidimensional business planning model are respectively contained in a value table and a lookup table of a lookup spreadsheet worksheet. A dimension can also comprise either a dynamic dimension, changeable after the federated multidimensional business planning model is created, or a static dimension, not changeable after the federated multidimensional business planning model is created. In at least some configurations, each of the first multidimensional business planning model and the second multidimensional business planning model is identified by a model type and a model creator. Each dimension can also be configured to have a unique rollup defined by a dimension hierarchy of data members within the dimension and a data member parent for each data member in the dimension. The computing device means can further be configurable for utilizing user input through a model setup spreadsheet worksheet for defining a rollup operator relationship between each dimension data member and the corresponding dimension parent data member. In some configurations, the computing device means is configurable for utilizing user input through a model setup spreadsheet worksheet for defining each user by a user role and a user access for each of the first multidimensional business planning model, the second multidimensional business planning model and the integrated first multidimensional business planning model and second multidimensional business planning model. Additionally, the computing device means is further configurable for utilizing user input through a data load spreadsheet worksheet for loading data into a model for an identified member of a first dimension and a corresponding member of a second dimension, wherein the corresponding member of the second dimension is variable and the variation acts as a filter for the loaded data.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A shows a model setup spreadsheet screen display according to aspects of embodiments of the disclosed subject matter;

FIG. 1B shows a model setup spreadsheet screen display according to aspects of embodiments of the disclosed subject matter;

FIG. 1C shows a model setup spreadsheet screen display according to aspects of embodiments of the disclosed subject matter;

FIG. 2 shows a model map spreadsheet screen display according to aspects of embodiments of the disclosed subject matter;

FIG. 3A shows a model formula spreadsheet screen display according to aspects of embodiments of the disclosed subject matter;

FIG. 3B shows a model formula spreadsheet screen display according to aspects of embodiments of the disclosed subject matter;

FIG. 4 shows a dimension setup spreadsheet screen display according to aspects of embodiments of the disclosed subject matter;

FIG. 5 shows a data load spreadsheet screen display according to aspects of embodiments of the disclosed subject matter;

FIG. 6 shows a lookup spreadsheet screen display according to aspects of embodiments of the disclosed subject matter;

FIG. 7A shows a Host-Run-Report spreadsheet screen display according to aspects of embodiments of the disclosed subject matter;

FIG. 7B shows a Host-Run-Report spreadsheet screen display according to aspects of embodiments of the disclosed subject matter;

FIG. 7C shows a Host-Run-Report spreadsheet screen display according to aspects of embodiments of the disclosed subject matter;

FIG. 8A shows a Host-Design-Model spreadsheet screen display according to aspects of embodiments of the disclosed subject matter;

FIG. 8B shows a Host-Design-Model spreadsheet screen display according to aspects of embodiments of the disclosed subject matter; and

FIG. 8C shows a Host-Design-Model spreadsheet screen display according to aspects of embodiments of the disclosed subject matter.

### DETAILED DESCRIPTION

According to aspects of the disclosed subject matter, business unit planning can be made more productive and effective due to non-technical businessmen being able to generate and share their own models, analytics and reports without the assistance of dedicated IT or Professional Services functionalities, according to aspects of embodiments of the disclosed subject matter. Accordingly, as an example, a functional business user of the systems and methods disclosed in the present application can make faster and better decisions, e.g., without the need for waiting until the end of a long business planning cycle. In order for the proposed self-service modeling to be effective, a software solution is currently proposed to be highly interactive, extremely intuitive and to utilize an iterative development paradigm, and eliminate or at least alleviate the need for such businessmen to have to work with complex tools or technically sophisticated interfaces.

According to one aspect of the disclosure, a method and system are proposed, which may comprise a computing module executing on a computing device, e.g., including a comprehensive model designer that can allow business planning models to be designed with a model setup, a model relationship with other models and common model formulas. In another aspect of the disclosure, a method and a computing module executing on a computing device can include an intuitive user interface paradigm. In still another aspect of the disclosure, a method and a computing module executing on a computing device can include an interactive and iterative model design process. A proposed design process can have more than one iteration and may apply an incremental design approach. Furthermore, the proposed design process can provide for more or less immediate reporting on model data relationships, model hierarchies and model formulas. As such, a comprehensive business modeling designer with an intuitive user interface paradigm as well as an interactive and iterative modeling process is proposed.

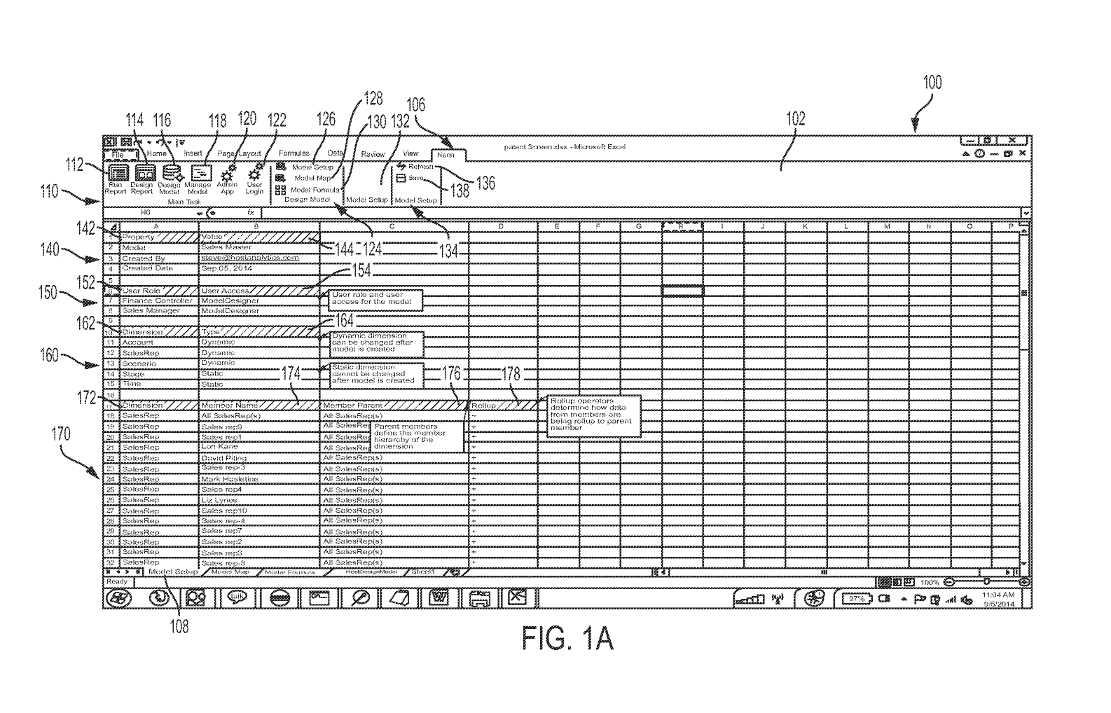

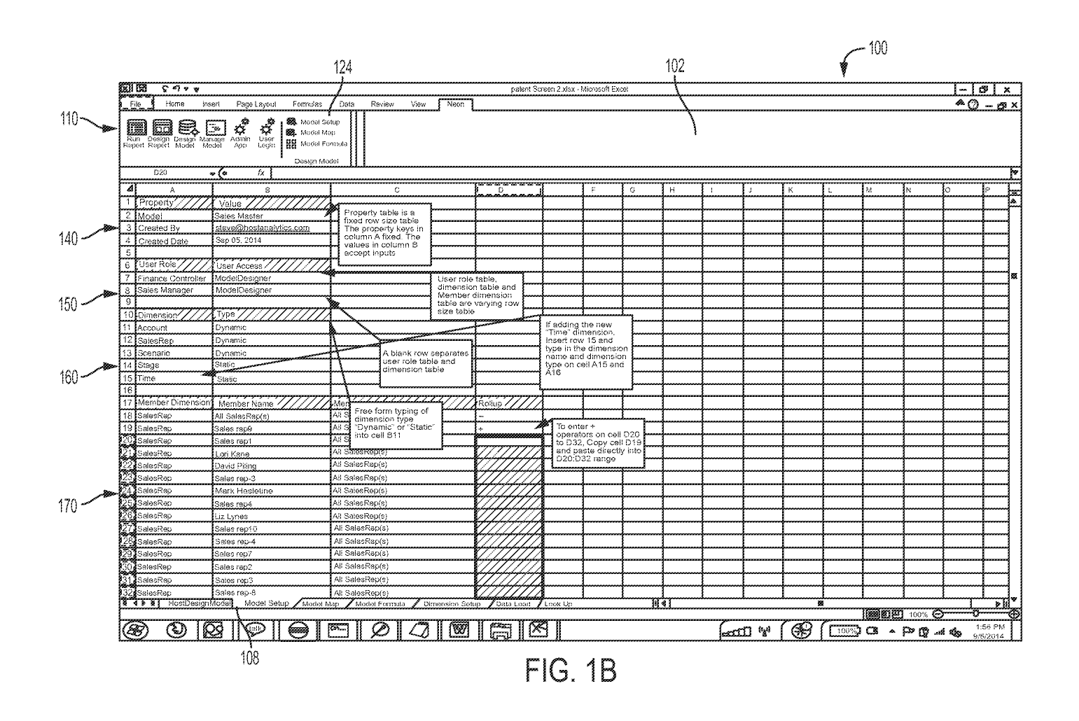

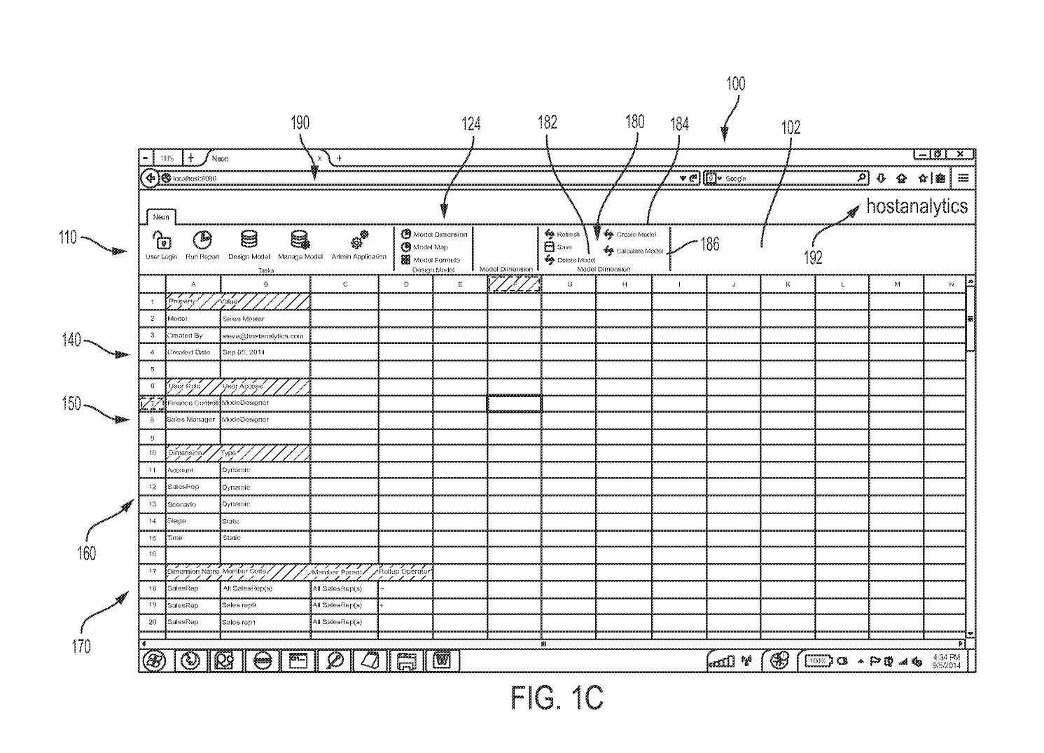

A proposed model designer according to aspects of embodiments of the disclosed subject matter may comprise components that can be used to create a multi-dimensional model for business planning purposes. The components of the model designer can include, e.g., a model setup, a map setup, a dimension setup, a data loader and a member lookup. Model setup worksheet screen 100, as illustrated by way of example in FIGS. 1A-C, can be utilized to define, e.g., model properties, a user role and user access for a model. In addition, the model setup worksheet screen 100, as illustrated, by way of example, in FIGS. 1A-C, can define the dimensions and the member properties for the model. The model setup worksheet screen 100, as illustrated, by way of example, in FIG. 1B, can provide for the model designer layout of a number of tables, e.g., a four table's layout. A table may have a fixed row sized table. The other three tables may be, e.g., varying row sized tables. Common spreadsheet user interface actions including, e.g., free form typing, copy/paste and insert/delete of row/column may be utilized by the user, e.g., to enter the model design data. For example, as shown in FIG. 1B adding a new row, e.g., for a “Time” dimension in FIG. 1B can be done by inserting a new blank row (“15”) and free form typing in “Time” in the “Dimension” column 162 and “Static” in the “Dimension Type” column 164. In addition, as an example, a symbol such as the + symbol can be added to rows 19 and above in the “Rollup” column 178, by adding it in cell or block D19 in row 19 and dragging it down into the succeeding rows, e.g., down to block D32. The model setup worksheet screen 100, as illustrated, by way of example, in FIG. 1C, can be accessed from a web browser, with the user interface layout and actions consistent across all user devices.

A model setup worksheet screen 100 may include an application ribbon or toolbar 102, with, e.g., an application tab 106, e.g., with an application name, such as “Neon.” The model setup worksheet screen 100 may also include a “Model Setup” worksheet tab 108. A task selection block 110 may include a “Run Report” icon 112, a “Design Report” icon 114, a “Design Model” icon 116, a “Manage Model” icon 118, an “Admin App” icon 120 and a “User Login” icon 122. A “Design Model” task 124 may include a “Model Setup” icon 126, a “Model Map” icon 128 and a “Model Formula” icon 130. A “Model Setup” block 132, 134 may include a “Save” icon 138 and a “Refresh” icon 136.

A property definition section 140 may include a “Property” table column 142 and a “Property Value” table column 144. The property definition section 140, by way of example, constitutes a fixed row sized table, e.g., with the “Property” table entries fixed and the “Value” column accepting data entries. Free form typing may, as elsewhere in the worksheets disclosed, be utilized to enter other than fixed table entries. A user definition section 150 may include a “User Role” table column 152 and a “User Access” table column 154, each relating to the selected “Sales Master” model. A dimension identification section 160 may include a “Dimension” column 162 and a “Dimension Type” column 164, wherein “Dynamic” indicates a dimension, e.g., “Account,” that can be changed after a model is set up and “Static” indicates the dimension, e.g., “Stage” that cannot be so changed. A dimension breakout section 170 may include a “Dimension” table column 172, a “Member Name” column 174 a “Member Parent” column 176 and a “Rollup” column 178. The “Member Parent” table column entries indicate the member hierarchy of a dimension, e.g., “All Sales Rep(s)” and the rollup operators can be used to indicate how rollup is determined. A blank row can separate the dimension identification section 160 from the dimension breakout section 170, as may also be true as to property definition section 140, user definition section 150 and dimension identification section 160.

As illustrated, by way of example, in FIG. 1C the model setup worksheet screen 100 may include a “Model Dimension” task bar 180, which may in turn include a “Delete model” icon 182, a “Create Model” icon 184 and a “Calculate Model” icon 186. The “Neon” application toolbar or task selection block 110 and spreadsheet worksheet may be emulated through calling up an application, e.g., through a web-browser, e.g., having a browser identification icon 190 and a browser provider identification 192.

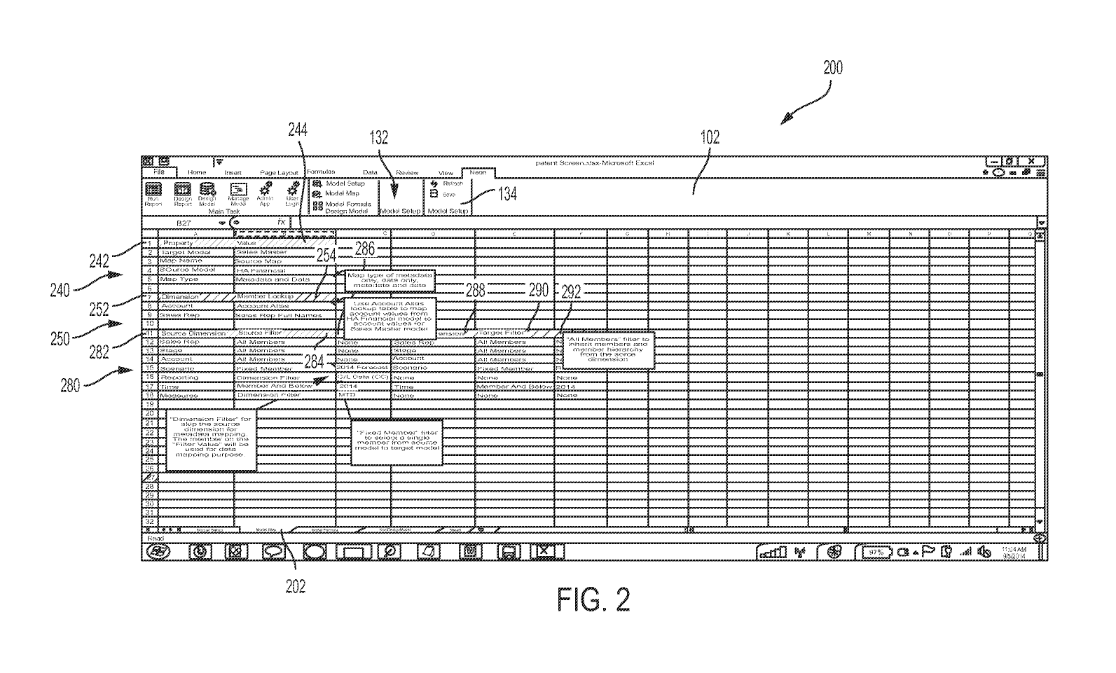

A model map worksheet screen 200, as illustrated, by way of example, in FIG. 2, having a “Model Map” name tag 202, can be utilized to define multi-dimensional mapping of both metadata and data between, e.g., between two models, e.g., defined in a source model and a target model. A source/target definition section 240 may include, e.g., a property column 242 and a value column 244. The property column 242 may include, for example, “Target Model” “Map Name,” “Source Model” and “Map Type” entries and corresponding “Sales Manager” (for example, referring to Sales Manager target model) “Source Map” (for example, referring to Source Map being the name of this map definition) “HA Financial” (for example, referring to Host Analytic Financial model) and “Metadata and Data” (for example, referring to Metadata and Data mappings between source model and target model) entries in the value column 244. Different values may be entered into the value column 244, e.g., “Map Type” could be “Data” only, “Metadata” only or “Metadata and Data.”

The model map worksheet screen 200 can comprise mapping properties, e.g., a dimension member identification section 250, which may include a “Dimension” table column 252 and a “Member Lookup” table column 254 and the “Member Lookup” table column 254 may include such entries as “Account Alias” for the “Account” dimension and “Sales Rep Full Names” for the “Sales Rep” dimension. An “Account alias” in the “Member Lookup” table column 234 for the “Dimension” table entry “Account,” can be utilized to map account values from the selected “Source Model,” i.e., “HA Financial” to the selected “Target Model,” i.e., “Sales Master,” e.g. utilizing the “Source Dimension” table column 282, “Source Filter” column 284 and “Source Value” column 286 and the “Target Dimensions” column 288, “Target Filter” column 290 and “Target Value” column 292 from the source-target dimension mapping section 280.

The model map worksheet screen 200 can comprise mappings for each dimension, e.g., in a source-target dimension mapping section 280, which may include, e.g., a “Source Dimension” table column 282, a “Source filter” column 284, e.g., a “Source Value” column 286, a “Target Dimensions” column 288, a “Target Filter” column 290 and a “Target Value” column 292. The mappings for each dimension, e.g., in the source-target dimension mapping section 280, may include, e.g., “Sales Rep,” “Stage,” “Account,” “Scenario,” “Reporting,” “Time” and “Measures,” appearing in the “Source Dimension” table column 282, for which the corresponding entries “All Members,” “All Members,” “All Members,” “Fixed Member,” “Dimension Filter,” “Member and Below” and “Dimension Filter” can appear in the “Source Filter” column 284, and, e.g., the entries “None,” “None,” “None,” “2014 Forecast” “G/L Data CC,” (general ledger data cost center) “2014,” and “MTD” (month-to-date) can appear in the “Source Value” column 286. Identical entries can appear in the “Target Dimensions” column 288, the “Target Filter” column 290 and the “Target Value” column 292, with the exception of “None” entries appearing in the “Reporting” and “Measures” rows. An “All Members” filter in the “Target Value” column 292 can be utilized, e.g., to inherit members and member hierarchy from the corresponding source dimension. A “Fixed Member” filter may be utilized, e.g. to select a single sourced model member to include in the target model. A “Dimension Filter” may be utilized, e.g., to skip a source dimension, e.g., for metadata mapping, whereby a “Filter Value” can then be utilized for data mapping purposes.

As examples, the “Map Type” data entry could have alternative values, such as, Metadata Only,” “Data Only” or “Metadata and Data,” as shown. The “Account Alias” member lookup table, as an example, may be selected by entering in the appropriate row and column, as shown in FIG. 2, e.g., to map account values from the source “HA Financial” model to the account values for the target “Sales Master” model, as identified in the source/target definition section 240. An “All Members” entry, e.g., in the “Target Value” column 292 may be utilized, e.g., to inherit members and/or member hierarchy from the source dimension. A “Dimension Filter” entry in the “Reporting” row for the “Source Filter” column 284 may be utilized, e.g., to skip the source dimension for metadata mapping, whereby, e.g., the member in the “Source Filter” column can be utilized for mapping purposes. The “Fixed Member” filter value in “Source Filter” column 284 may, by way of example, be utilized to select a single designated member, e.g., in the “Scenario” row of either or both of the “Source Value” column 286 or the “Target Value” column 292.

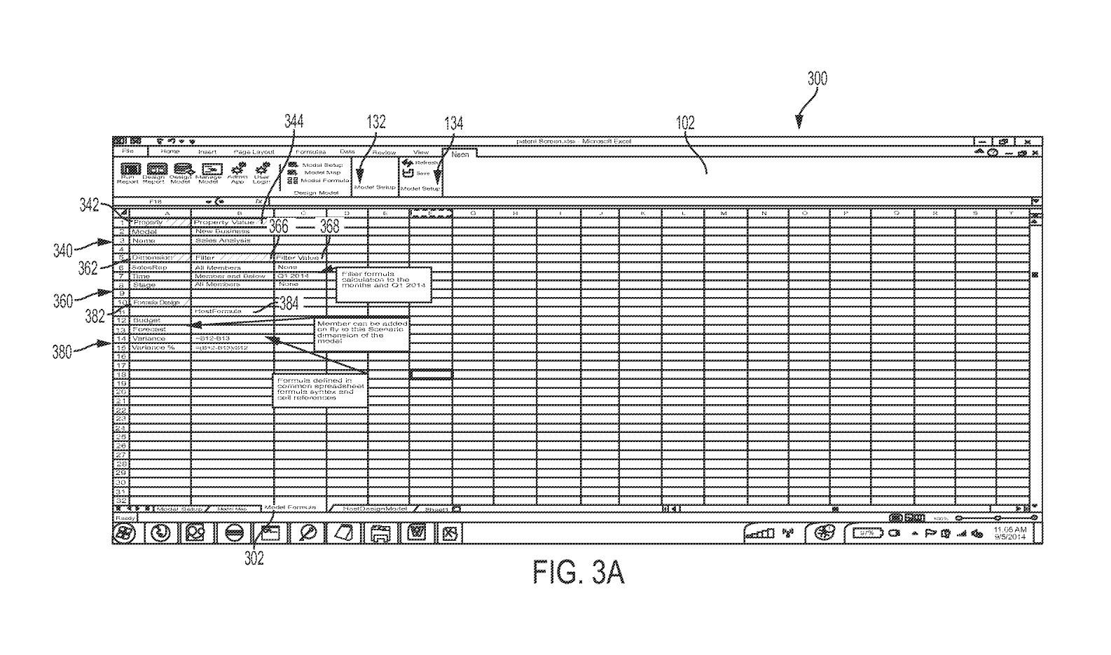

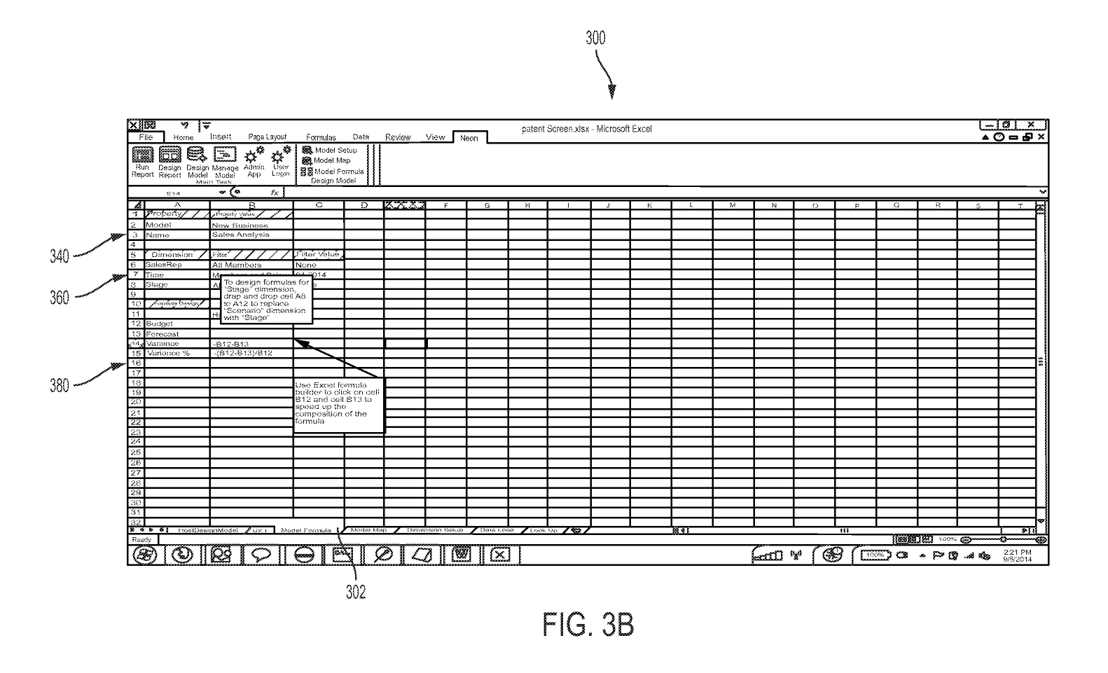

A “Model Formula” spreadsheet screen 300, illustrated, by way of example, in FIGS. 3A-B, having a “Model Formula” worksheet name tag 302, can be utilized to define multi-dimensional formulas for a model. The formula setup may comprise formula properties and dimensional filters and formulas. The formulas can be, e.g., defined in a one or two dimensional layout, e.g., with cell base formula syntax. A formula model definition section 340 may have a “Property” column 342 and a “Value” column 344. A formula identification section 360 may include, e.g. a “Dimension” column 362 and a “Filter” column 366 and a “Filter” column 366. A formula design section 380 may include, e.g., a “Formula Design” column 382 and a “Host Formula” column 384.

In the “Model Formula” spreadsheet screen 300, illustrated, by way of example, in FIG. 3A, the “Filter Value” column 368 can be utilized, e.g., to produce calculation for the months in Q1 of 2014, the “Filter Value” in the “Filter Value” column 368. A member(s) may be added, e.g., on the fly, for a “Forecast” dimension in the scenario in the “Formula Design” column 382. The “Formula Design” column 382 may include, for example, “Budget” (for example, budget member which can be already defined in the model) “Forecast” (for example, forecast member which can be already defined in the model) “Variance” (for example, variance member which can be not yet defined in the dimension and can be added to the dimension) and “Variance %” (for example, variance % member which can be not yet defined in the dimension and can be added to the dimension). A formula may be defined, e.g., in common spreadsheet syntax, e.g., Microsoft Excel®, e.g., with common cell references, such as “=B12−B13” or “=(B12−B13)/B12” as illustrated in the “Host Formula” column 384. In the “Model Formula” spreadsheet screen 300, illustrated, by way of example, in FIG. 3B, e.g., a drag/drop user interface action and a native Excel® formula Builder™ can be utilized, e.g., to design model formulas. As an example, in order to design a formula(s) for a “Stage” dimension listed in the “Dimension” column 362, the user may drag and drop a cell A8 to A12, as illustrated in FIG. 3B, e.g., to replace the members “Budget”, “Forecast”, “Variance” and “Variance $” of the “Scenario” dimension with the members such as “Initial Call Setup”, “Sales Qualified Opportunity”, “Initial Deep-Dive Completed” of the “Stage dimension. Spreadsheet tools, e.g., Excel® “formula Builder,”™ may be utilized to click on particular cells, such as cell B12 and/or B13, e.g., to speed up building the formulas in cells B14 and B15 in FIG. 3B, in the “Host Formula” column 384.

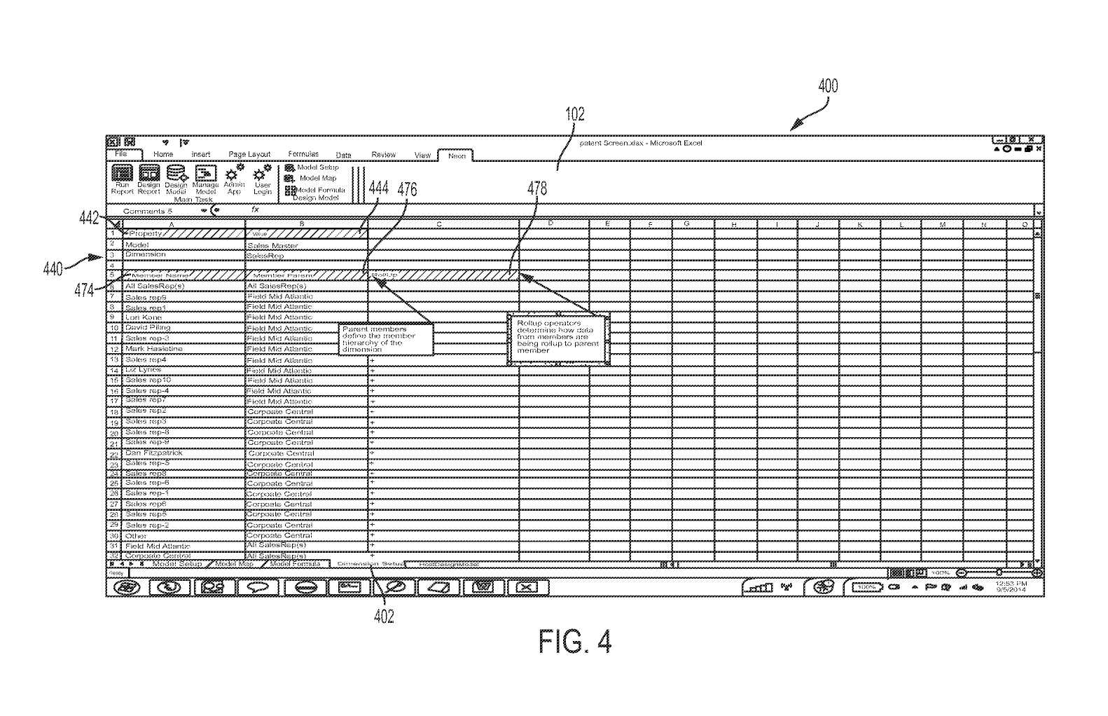

A dimension setup spreadsheet screen 400, illustrated, by way of example, in FIG. 4, and having a “Dimension Setup” worksheet name tag 402, can be utilized to define the members and the member hierarchy for a model. The dimension setup spreadsheet screen 400, having a hierarchy identification section 440, with a “Property” column 442 and a “Value” column 444, and a hierarchy identification section with a “Member Name” column 474, a “Parent Member” column 476 and a “Rollup” column 478 can also be used to define members of a dimension that does not map to a dimension of another model. Parent members in the “Parent Member” column 476 can define the hierarchy for the Members in the “Member Name” column 474 for a dimension, such as the “Sales Rep” dimension listed in the “Value” column 444 of FIG. 4. Rollup operators in the “Rollup” column 478 can be utilized to determine how data from a member rolls up for a parent member, e.g., is the same (=) or is an addition (+).

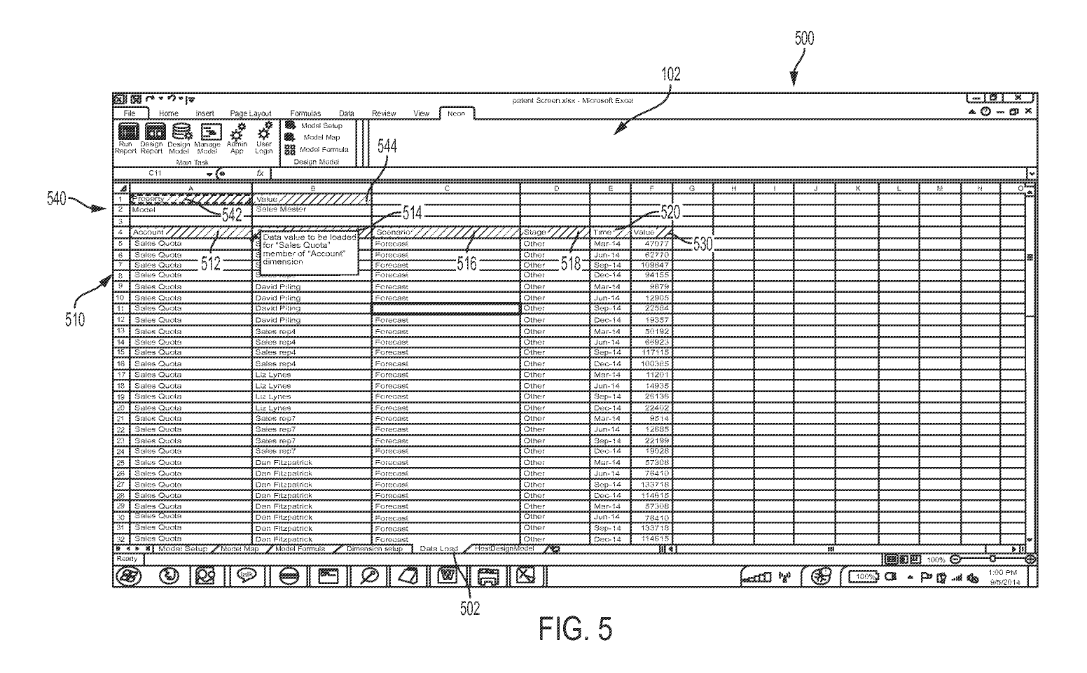

A data load worksheet screen 500, having a “Data Load” worksheet name tag 502, illustrated, by way of example, in FIG. 5, can be utilized to load data into dimensional interactions of a model. The data load worksheet screen 500 can comprise a property definition section 540, which may have a “Property” table column 542 and a “Value” column 544. The data load worksheet screen 500 may also have a “Data Loading” section 510 which may include, e.g., an “Account” column 512, a “Sales Reps” column 514, a “Scenario” column 516, a “Stage” column 518, a “Time” column 520 and a “Value” column 530 for members of each dimension, such as, the “Sales Quota” dimension for the “Sales Master” model, from “Value” column 544. As illustrated the data values to be loaded are for a “Sales Quota” member of an “Account” dimension in the “Sales Master” model, for a particular “Sales Rep”, and a “Scenario,” “Stage” and “Time.”

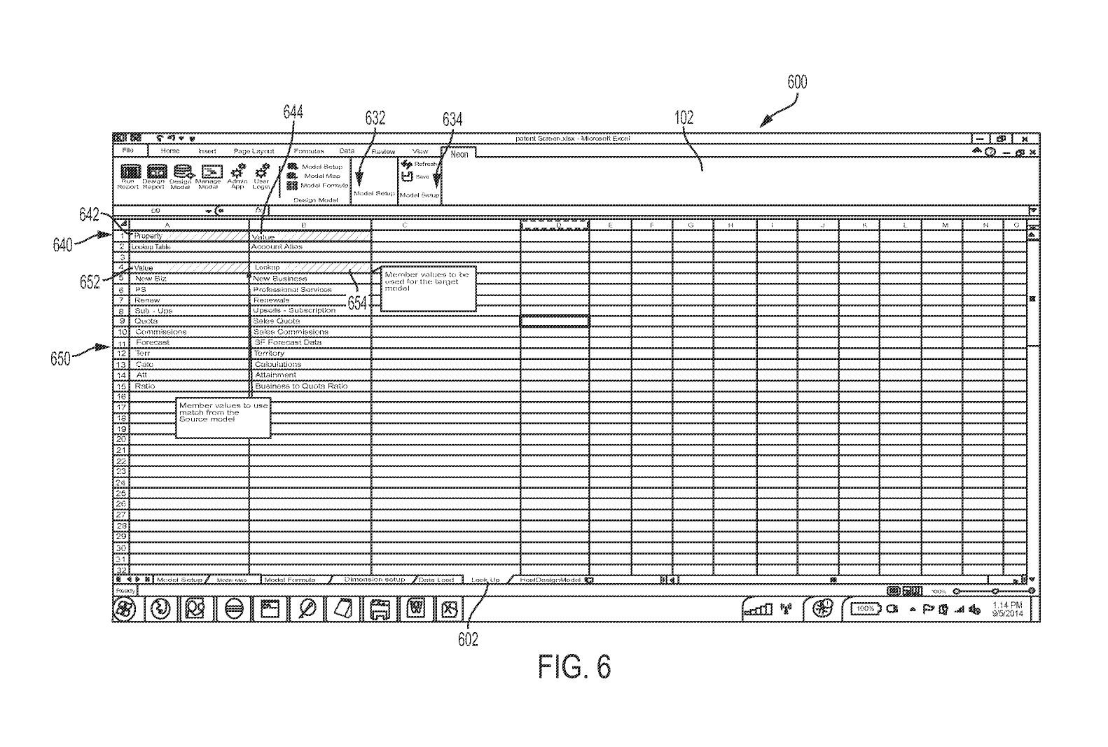

The member “Lookup” worksheet screen 600, having a “Lookup” worksheet name tag 602, illustrated, by way of example, in FIG. 6, can be utilized to define a value to lookup mapping, e.g., for a source member and a target member. The member “Lookup” worksheet screen 600 may have a property definition section 640, with, e.g., a “Property” column 642 and a “Value” column 644. The member “Lookup” worksheet screen 600, may also have a value lookup section 650, with a “Value” column 652 and a “Lookup” column 654. The member values in the “Value” column 652 of the value lookup section, e.g., for a source model can be designated to be converted to a lookup value in the “Lookup” column 654 in the target model. By way of example, “New Biz” in the former can be mapped to “New Business” in the latter, “PS” in the former can be mapped to “Professional Services” in the latter, “Renew” in the former can be mapped to “Renewals” in the latter, and so forth.

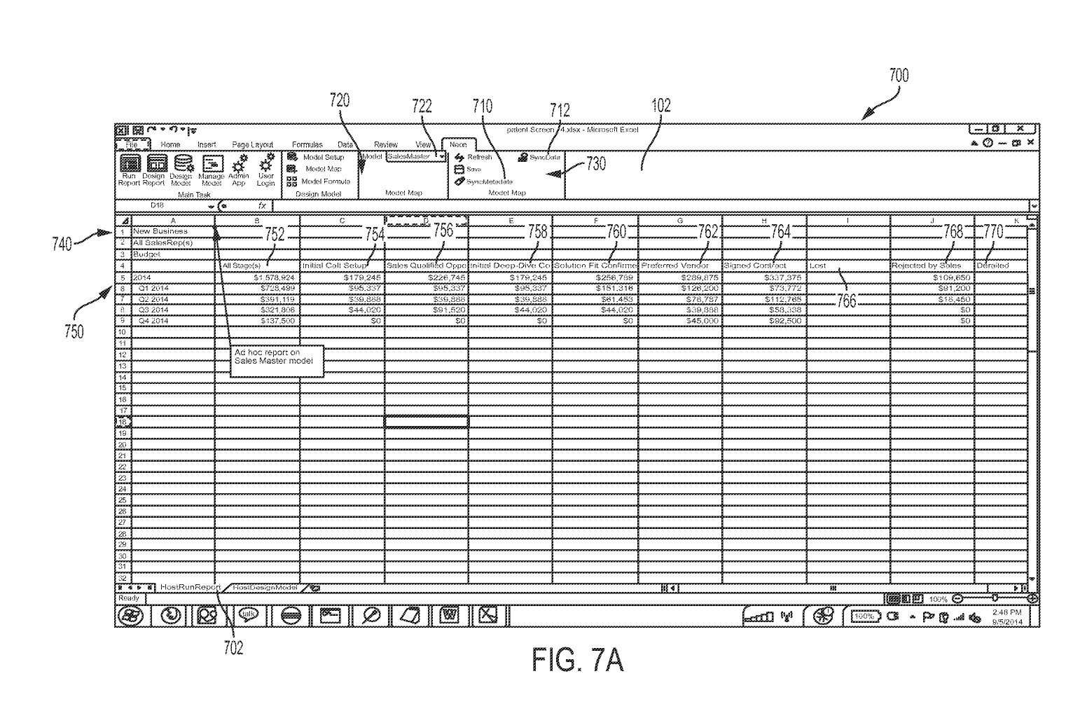

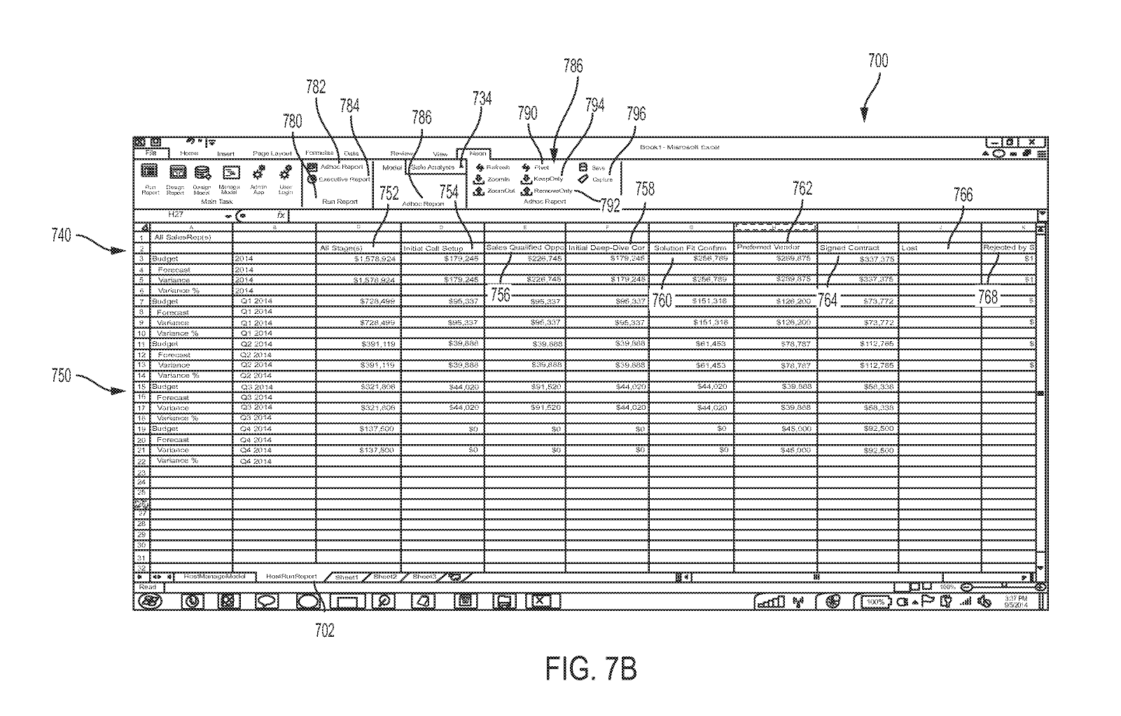

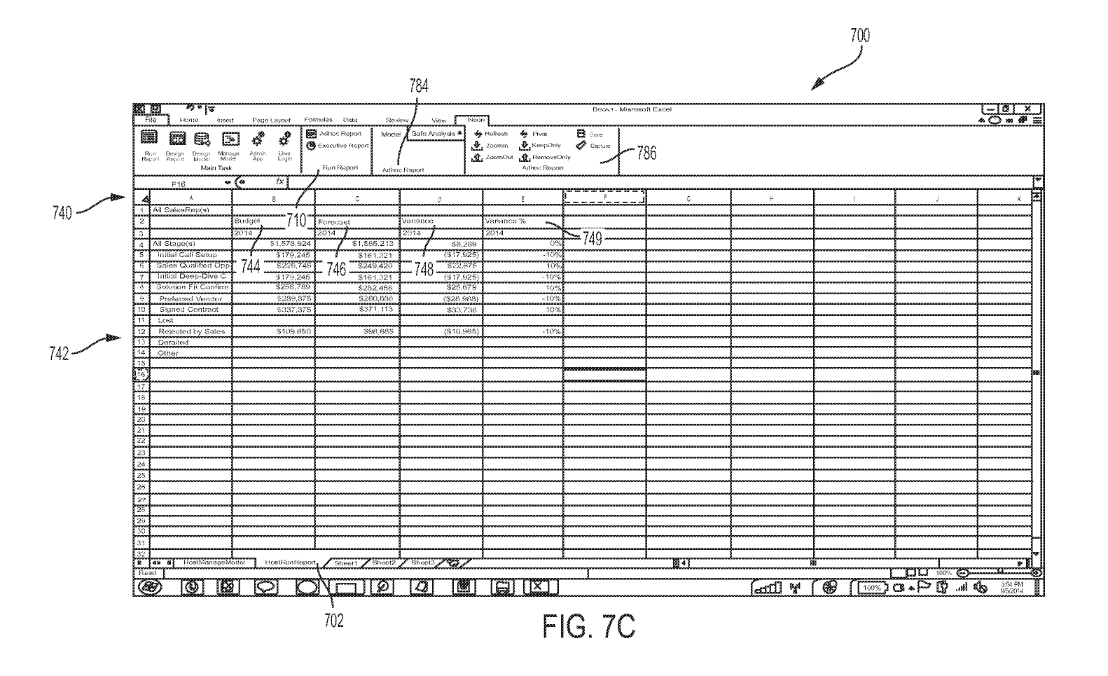

As illustrated, by way of example, in FIGS. 7A and 7B, according to aspects of the disclosed subject matter the system and method may, e.g., run an ad hoc report on a “HostRunReport” worksheet screen 700, having a “Host-Run-Report” worksheet name tag 702. The “HostRunReport” worksheet screen 700 can be utilized, e.g., to analyze the dimensions and the member hierarchy of a model. According to aspects of the disclosed subject matter the system and method may, e.g., run an “Model Map” report utilizing the “HostRunReport” worksheet screen 700, illustrated, by way of example, in FIG. 7A. A model map block 720 on the application ribbon or toolbar 102 can have a model selection portion with a model selection pop down 722 and model map block 730, with the addition of a “SyncMetadata” icon 710 and “SyncData” icon 712. The “Model Map” report may be selected utilizing the “Model Map” icon 128 in the “Design Model” task 124 as illustrated in FIG. 1A. A “Design Model” block may be selected utilizing the “Design Model” icon 116 in the task selection block 110 as illustrated in FIG. 1A.

A “Report Title” section 740 can include the title, e.g., “New Business” budgeted for all sales reps, e.g., in the selected “Sales Master” model. In a “Data Report” section 750 there can be included an “All Stages” column 752, an “Initial Call” column 754, a “Sales Qualified Opportunities” column 756, an “Initial Deep-Dive Confirmed” column 758, a “Solution Fit Confirmed” column 760, a “Preferred Vendor” column 762, a “Signed Contract” column 764, a “Lost” column 766, a “Rejected by Sales” column 768 and a “Derailed” column 770. The HostRunReport” worksheet screen 700 of FIG. 7A can be utilized, e.g., for ad hoc reporting, e.g., for immediate feedback during each iterative design step(s), such as for an “Ad Hoc” report on budgeted new business for all sales representatives in a selected model, e.g., the “SalesMaster” model. FIG. 7B illustrates an “All Sales Rep(s)” report on the selected “Sales analysis” model, selected in the model selection pull-down 734. The HostRunReport” worksheet screen 700 of FIGS. 7A and 7B can be utilized to analyze the dimensions and the member hierarchy of a model. A model map block 720, 730 may be selected from the “Design Model” task 124 of the HostRunReport” worksheet screen 700 of, as illustrated in FIG. 1A.

According to aspects of the disclosed subject matter the system and method may, e.g., run an ad hoc report on the HostRunReport” worksheet screen 700, illustrated, by way of example, in FIGS. 7B and 7B, of which the HostRunReport” worksheet screen 700 of FIG. 7B can be utilized to analyze a new model with the additional members. A “Run Report” tool block 780 may be selected utilizing the “Run Report” icon 112 in the task selection block 110 as illustrated in FIG. 1A. The “Run Report” tool block 780 can have an “AdHoc Report” selection icon 782 and an “Executive Report” selection icon 784, with the former selecting an “AdHoc Report” block 786, which may contain a model selection pull-down 734. As illustrated, the Model” selection pull-down 734 is selecting a “Sales Analysis” Model. According to aspects of the disclosed subject matter the system and method may, e.g., run an ad hoc report on the HostRunReport” worksheet screen 700, illustrated, by way of example, in FIG. 7B, that can be utilized for model design tasks. The “AdHoc Report” block 786 may have additional icons for ““Pivot,” 790, Remove Only” 792, “Keep Only” 794 and “Capture” 796. A “Report” section 742, illustrated, by way of example, in FIG. 7C can have a “Budget” column 744, a “Forecast” column 746, a “Variance” column 748 and a “Variance %” column 749, the entries in which may be sorted by, e.g., year, e.g., 2014, for each of the above noted stages from FIGS. 7A and 7B and rolled up for “All Stage(s).”

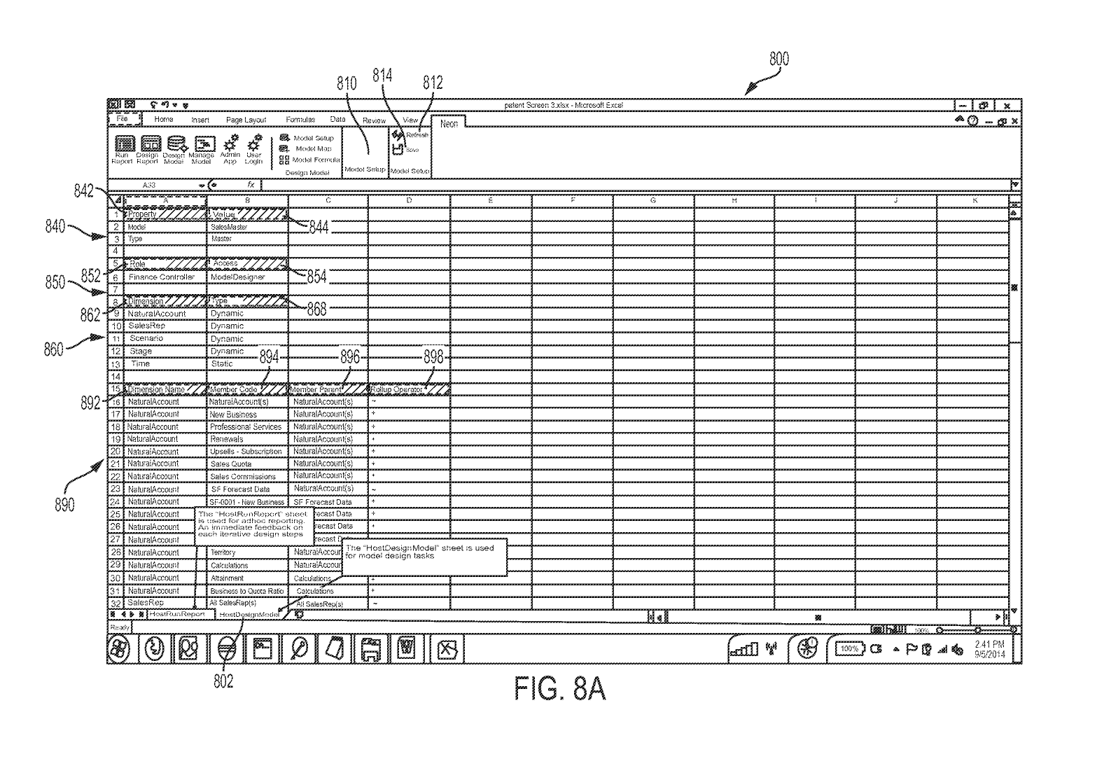

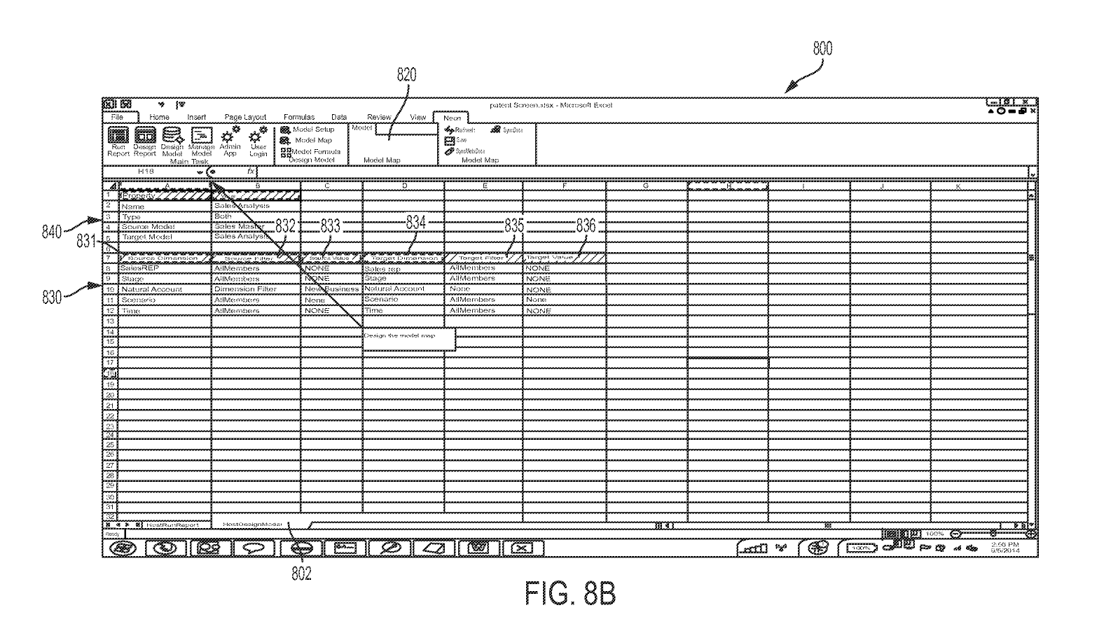

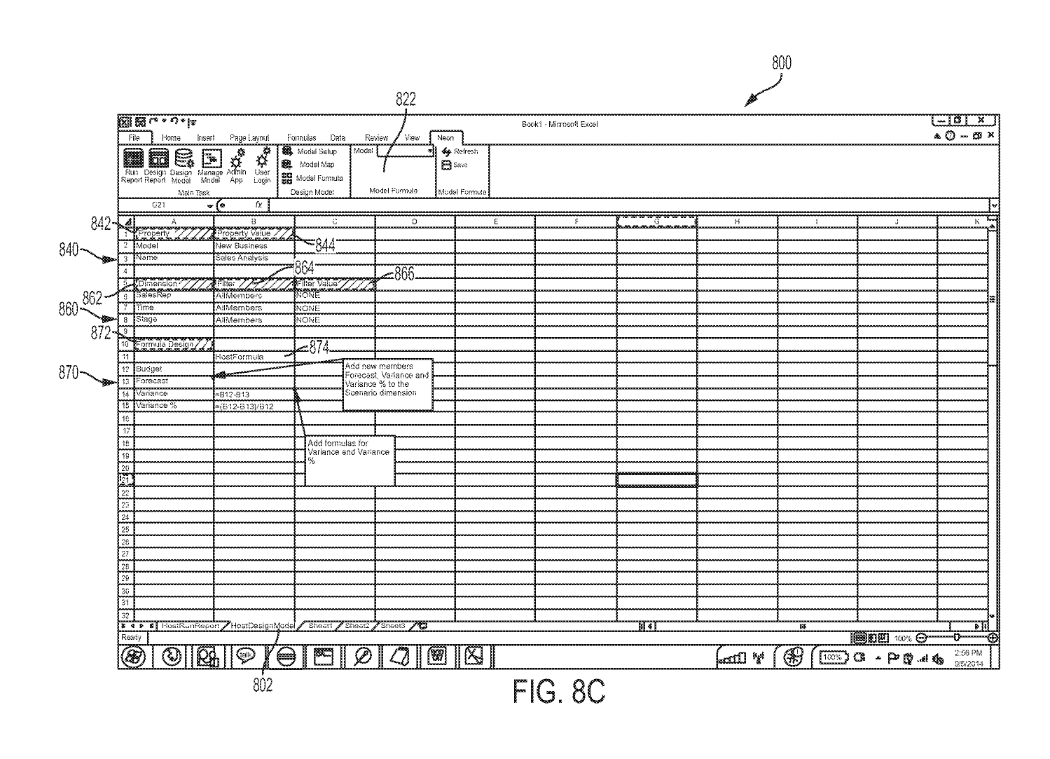

A design model worksheet screen 800, having a “HostDesignModel” nametag 802, can be utilized, e.g., to create a “Sales Analysis” sub-model, as illustrated, by way of example, in FIGS. 8A-C. Analysis of a model, e.g., a “SalesMaster” model on the design model worksheet screen 800 of FIG. 8A, can be utilized to design models. The “SalesMaster” model can be listed in the “Value” column 844 of a model identification section 840, and indicated to be a “Master” “Type” of report. New members and design formulas may be added, e.g., to models in FIGS. 8A-C. A “Model Setup” block 810 can include a “Refresh” icon 812 and a “Save” icon 814. A model identification section 840 in FIG. 8A can have a “Property” column 842 and a “Value” column 844. A member definition section 850 can have a “Role” column 852 and an “Access” column 854. A dimension identification section 860 can have a “Dimension” column 862 and “Type” column 868. A dimension information section 890 can have a “Dimension Name” column 892, a “Member Code” column 894, a Member Parent” column 896 and a “Rollup Operator” column 898.

A “Model Map” block 820 of FIG. 8B can be utilized to map models together. A “Source/Target” mapping section 830 in FIG. 8B can include a “Source Dimension” column 831, a “Source Filter” column 832, a “Source Value” column 833, a “Target Dimension” column 834, a “Target Filter” column 835 and a “Target Value” column 836, which can be utilized to map a source model and its dimensions to a target model.

A “Model Formula” block 822 in FIG. 8C can be utilized to design models by, e.g., creating and adding new formulas for the various models. A formula design section 870 in FIG. 8C can have a “Formula Design” column 872 and a “HostFormula” column 874. A dimension identification section 860 in FIG. 8C can have a “Dimension” column 862, a “Filter” column 864 and a “Filter Type” column 866.

According to aspects of embodiments off the disclosed subject matter, a model designer can be provided with intuitive user interfaces. Business users familiar with, e.g., building business models utilizing a spreadsheet tool can become proficient with the proposed model designer in a very short period of time. According to aspects of the disclosed subject matter a user interface for the model designer can comprise consistent usage of a set of multi-column tables that can reside on top of a grid base data sheet. The number of rows per table can be fixed as well as dynamic. The user interface of the model designer can be run on any common web browser (i.e. Explorer®, Firefox®, Chrome™, Sapphire™), on any spreadsheet tool (i.e. Microsoft Excel®) or on any mobile device (i.e. an Apple iPad®). Common user actions for building business models in a spreadsheet tool can be supported by the disclosed model designer according to aspects of the disclosed subject matter. User actions including free form typing, copy/paste of a collection data cell(s), insert/delete of rows/columns, resize row width and column height, right click menu, double click, drag/drop, etc. can be supported. An example is the model map worksheet screen 200 discussed with respect to FIGS. 2A-B. The model map worksheet screen 200 can be accessed from a web browser, e.g., as illustrated in FIG. 1c. The user interface layout and actions can be consistent across all devices.

According to aspects of the disclosed subject matter the model designer can be an interactive and iterative design process. The disclosed model designer can allow the model setup, map setup, formula setup, dimension setup and data loader to be designed as incremental steps. Each design step can provide immediate feedback, e.g., in an immediate feedback loop, that can allow for efficient validation of a design. The iterative model design process can be very user friendly and much more effective than the standard design concept of going through many design steps before the design can be reviewed and validated. The model designer, e.g., can be working side by side with an ad hoc reporting tool and provide an immediate feedback loop on each of the design steps. The effects of, e.g., adding a designer step, e.g., adding new members along with member formulas, can be analyzed immediately. Using the ad hoc reporting tool, resulting formulas can be quickly validated.

According to aspects of embodiments of the disclosed subject matter the system and method proposed can encourage users to leverage the system and method by utilizing the multidimensional modeling framework, the federated modeling manager, the model designer, the model slice designer and the user interface components. The multidimensional modeling framework can be utilized for the management of a collection of multidimensional models and the relationship(s) among them. The multidimensional model according to aspects of embodiments of the disclosed subject matter may consist of model dimensions, dimension members, dimension hierarchies, dimension member formulas and model data. The mapping between models may be defined by a model slice for a source model(s) and a target model(s). A source model can map to many target models and a target model can map to multiple source models.

According to other aspects the federated model manager may be utilized to control, e.g., the initial and the on-going design of either top-down model(s) or the bottom-up model(s). The federated model manager can also manage design tasks for the bottom-up model(s). The federated model manager can also ensure that the design(s) of the bottom-up model(s) is consistent with the modeling requirement(s) from the top-down model(s). According to other aspects of the system and method of the disclosed subject matter the model designer can be utilized to design the dimension(s), the dimension member(s), the dimension hierarchy(ies) and the dimension member formula(s) for a model(s). In addition the disclosed dimension member formula designer(s) can support common spreadsheet formula syntax for ease of use and for quicker user adoption. Further, the model slice designer(s) can be utilized to design the multidimensional slice(s) between a source model(s) and a target model(s). A model slice may furthermore be defined by a dimension(s), a dimension filter(s) and dimension filter values of a source model(s) and a target model(s).

According to aspects of embodiments of the disclosed subject matter the system and method may utilize user interface component(s) to, e.g., increase a speed-of-thought response time(s), e.g., on an ad hoc query(ies) as to a data interaction(s) of the model, e.g., through a user interface(s), e.g. from a Web browser(s), a spreadsheet application, e.g., Microsoft Excel® and a mobile device(s). The user interface component(s) can also support data write-back so that, e.g., data can be entered to validate a model design(s) in an iterative and interactive fashion. Aspects of embodiments can provide an optimized multi-dimensional model(s) for distributed calculations and queries. The disclosed comprehensive business modeler and planner can provide for high performance and can be highly scalable for enterprise performance management applications, such as Essbase® 2.0, Oracle® or the like. The disclosed subject matter can serve to empower financial users and engage operational users on multi-dimensional analysis and modeling, which can extend well beyond simply finance) applications. The tool can provide a single source of truth and comprehensive data.

According to aspects of embodiments of the disclosed subject matter, the proposed tool can provide a collaborative ability providing speed of thought analysis and modeling. Very short, e.g., sub-second response times on all queries can be achieved. The tool can support operation by the user on a wide variety of computing devices and consistent user experience, e.g., in the spreadsheet arena, which can also be leveraged. Efficient information sharing can be attained, e.g., approaching a Hyperion® Essbase® 2.0 running in the cloud, e.g., over the Internet. The disclosed subject matter in some sense resembles in ability to provide data visualization, however, Tableau simply provides graphical representations. The currently proposed tool can provide actual data so that a user may, e.g., perform a pivot. The tool, which not a spreadsheet tool, such as Excel, can mimic its functions and enable piggy-backing on similar user experience levels, reducing the learning curve for the use of the tool. Different areas of a business, perhaps using different financial and business planning tools, can better collaborate and share the use of actual financial data with the proposed tool. The proposed tool can capture the Excel®-type data in a multi-dimensional model so that users can better collaborate. As an example, the tool can allow users to use a web browser cube to report, plan and make business decisions, so as to provide through the multi-dimensional cube collaboration in the cloud.

The systems and methods according to aspects of the disclosed subject matter may utilize a variety of computer systems, communications devices, networks and/or digital/logic devices for operation. Each may in turn utilize a suitable computing device which can be manufactured with, loaded with and/or fetch from some storage device, and then execute, instructions that cause the computing device to perform a method according to aspects of the disclosed subject matter. A computing device can include without limitation a mobile user device such as a mobile phone, a smart phone and a cellular phone, a personal digital assistant (“PDA”), such as a BlackBerry®, a tablet, a laptop and the like. In at least some configurations, a user can execute a browser application over a network, such as the Internet, to view and interact with digital content, such as screen displays. Access could be over or partially over other forms of computing and/or communications networks. A user may access a web-browser, e.g., to provide access to applications and data and other content located on a web-site or a web-page of a web-site.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method. The user's computing device may be part of a network of computing devices and the methods of the disclosed subject matter may be performed by different computing devices, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” shall include any and all of the above discussed logic circuitry, communications devices and digital processing capabilities or combinations of these.

Certain embodiments of the disclosed subject matter may be described for illustrative purposes as steps of a method which may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementations may involve the function, functionalities and operations noted in the blocks of a block diagram occurring out of the order noted in the block diagram, including occurring simultaneously or nearly so, or in another order or not occurring at all.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at some times be transitory, e.g., in transit from a remote storage device to a computing device over a communication link. However, when the machine readable medium is tangible and non-transitory, the instructions will be stored, for at least some period of time, in a memory storage device, such as a RAM, a ROM, a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of creating a federated multidimensional business planning model comprising:
creating, via a computing device, a first multidimensional business planning model;
creating, via the computing device, a second multidimensional business planning model;
integrating, via the computing device, the first multidimensional business planning model with the second multidimensional business planning model, wherein the step of integrating comprises mapping, via the computing device, dimensions of the first multidimensional business planning model to the second multidimensional business planning model, utilizing user input through a model map spreadsheet worksheet defining, via the computing device, at least one source dimension in the first multidimensional business planning model corresponding with at least one target dimension in the second multidimensional business planning model.

2. The method of claim 1 wherein at least one of the at least one source dimension in the first multidimensional business planning model has a different dimension name than the corresponding at least one target dimension in the second multidimensional business planning model.

3. The method of claim 2 wherein the dimension name of the at least one source dimension in the first multidimensional business planning model and the dimension name of the corresponding at least one target dimension in the second multidimensional business planning model are respectively contained in a value table and a lookup table of a lookup spreadsheet worksheet.

4. The method of claim 1 wherein a dimension comprises either a dynamic dimension, changeable after the federated multidimensional business planning model is created, or a static dimension, not changeable after the federated multidimensional business planning model is created.

5. The method of claim 1 wherein each of the first multidimensional business planning model and the second multidimensional business planning model is identified by a model type and a model creator.

6. The method of claim 2 wherein each dimension has a unique rollup defined by a dimension hierarchy of data members within the dimension and a data member parent for each data member in the dimension.

7. The method of claim 6 further comprising, utilizing user input through a model setup spreadsheet worksheet, defining, via the computing device, a rollup operator relationship between each dimension data member and a corresponding dimension parent data member.

8. The method of claim 1 further comprising, utilizing user input through a model setup spreadsheet worksheet, defining, via the computing device, each user by a user role and a user access for each of the first multidimensional business planning model, the second multidimensional business planning model and the integrated first multidimensional business planning model and second multidimensional business planning model.

9. The method of claim 1 further comprising, utilizing user input through a data load spreadsheet worksheet, loading, via the computing device, data into a model for an identified member of a first dimension and a corresponding member of a second dimension, wherein the corresponding member of the second dimension is variable and the variation acts as a filter for the loaded data.

10. An apparatus for creating a federated multidimensional business planning model comprising:
a computing device configured to:
create a first multidimensional business planning model;
create a second multidimensional business planning model;
integrate the first multidimensional business planning model with the second multidimensional business planning model, wherein the integrating comprises mapping dimensions of the first multidimensional business planning model to the second multidimensional business planning model, utilizing user input through a model map spreadsheet worksheet defining at least one source dimension in the first multidimensional business planning model corresponding with at least one target dimension in the second multidimensional business planning model.

11. The apparatus of claim 10 wherein at least one of the at least one source dimension in the first multidimensional business planning model has a different dimension name than the corresponding at least one target dimension in the second multidimensional business planning model.

12. The apparatus of claim 11 wherein the dimension name of the at least one source dimension in the first multidimensional business planning model and the dimension name of the corresponding at least one target dimension in the second multidimensional business planning model are respectively contained in a value table and a lookup table of a lookup spreadsheet worksheet.

13. The apparatus of claim 10 wherein a dimension comprises either a dynamic dimension, changeable after the federated multidimensional business planning model is created, or a static dimension, not changeable after the federated multidimensional business planning model is created.

14. The apparatus of claim 10 wherein each of the first multidimensional business planning model and the second multidimensional business planning model is identified by a model type and a model creator.

15. The apparatus of claim 11 wherein each dimension has a unique rollup defined by a dimension hierarchy of data members within the dimension and a data member parent for each data member in the dimension.

16. The apparatus of claim 15 further comprising:
the computing device further configured to:
utilize user input through a model setup spreadsheet worksheet, defining a rollup operator relationship between each dimension data member and the corresponding dimension parent data member.

17. The apparatus of claim 10 further comprising:
the computing device further configured to utilize user input through a model setup spreadsheet worksheet to define each user by a user role and a user access for each of the first multidimensional business planning model, the second multidimensional business planning model and the integrated first multidimensional business planning model and second multidimensional business planning model.

18. The apparatus of claim 10 further comprising:
the computing device further configured to:
utilize user input through a data load spreadsheet worksheet to load data into a model for an identified member of a first dimension and a corresponding member of a second dimension, wherein the corresponding member of the second dimension is variable and the variation acts as a filter for the loaded data.

19. A computer readable medium storing instructions that, when executed by a computing device, cause the computing device to perform a method, the method comprising:
creating a first multidimensional business planning model;
creating a second multidimensional business planning model;
integrating the first multidimensional business planning model with the second multidimensional business planning model, wherein the integrating comprises mapping dimensions of the first multidimensional business planning model to the second multidimensional business planning model, utilizing user input through a model map spreadsheet worksheet defining at least one source dimension in the first multidimensional business planning model corresponding with at least one target dimension in the second multidimensional business planning model.

20. The machine readable medium of claim 19 wherein at least one of the at least one source dimension in the first multidimensional business planning model has a different dimension name than the corresponding at least one target dimension in the second multidimensional business planning model.

21. An apparatus for creating a federated multidimensional business planning model comprising:
a computing device means for creating a first multidimensional business planning model, creating a second multidimensional business planning model and integrating the first multidimensional business planning model with the second multidimensional business planning model, wherein the computing device means comprises integrating means for mapping dimensions of the first multidimensional business planning model to the second multidimensional business planning model, utilizing user input through a model map spreadsheet worksheet defining at least one source dimension in the first multidimensional business planning model corresponding with at least one target dimension in the second multidimensional business planning model.

22. The apparatus of claim 21 wherein at least one of the at least one source dimension in the first multidimensional business planning model has a different dimension name than the corresponding at least one target dimension in the second multidimensional business planning model.

23. The apparatus of claim 22 wherein the dimension name of the at least one source dimension in the first multidimensional business planning model and the dimension name of the corresponding at least one target dimension in the second multidimensional business planning model are respectively contained in a value table and a lookup table of a lookup spreadsheet worksheet.

24. The apparatus of claim 21 wherein a dimension comprises either a dynamic dimension, changeable after the federated multidimensional business planning model is created, or a static dimension, not changeable after the federated multidimensional business planning model is created.

25. The apparatus of claim 21 wherein each of the first multidimensional business planning model and the second multidimensional business planning model is identified by a model type and a model creator.

26. The apparatus of claim 22 wherein each dimension has a unique rollup defined by a dimension hierarchy of data members within the dimension and a data member parent for each data member in the dimension.

27. The apparatus of claim 26 further comprising:
the computing device means further being for utilizing user input through a model setup spreadsheet worksheet for defining a rollup operator relationship between each dimension data member and a corresponding dimension parent data member.

28. The apparatus of claim 21 further comprising:
the computing device means further being for utilizing user input through a model setup spreadsheet worksheet for defining each user by a user role and a user access for each of the first multidimensional business planning model, the second multidimensional business planning model and the integrated first multidimensional business planning model and second multidimensional business planning model.

29. The apparatus of claim 21 further comprising:
the computing device means further being for utilizing user input through a data load spreadsheet worksheet for loading data into a model for an identified member of a first dimension and a corresponding member of a second dimension, wherein the corresponding member of the second dimension is variable and the variation acts as a filter for the loaded data.
